(19) United States
(12) Patent Application Publication
(10) Pub. No.: US 2012/0292522 A1
(43) Pub. Date: Nov. 22, 2012

(54) METHOD FOR DETERMINING THE CONCENTRATION OF NITRIC ACID

(75) Inventor: Hubert Reger, Tubingen (DE)

(73) Assignee: RENA GMBH, Gutenbach (DE)

(21) Appl. No.: 13/576,119

(22) PCT Filed: Feb. 10, 2011
(86) PCT No.: PCT/EP11/00619

§ 371 Date: Jul. 30, 2012

(30) Foreign Application Priority Data
Feb. 12, 2010 (EP) PCT/EP2010/000890

(51) Int. Cl. G01J 1/42

(52) U.S. Cl. 250/372

(57) ABSTRACT

The present invention relates to the field of wet chemical treatment of silicon substrates. The invention particularly relates to a method for the determination of the concentration of nitric acid in aqueous process solutions as being used for the treatment of substrates such as those made from silicon. The method is based on the determination of nitrate by means of UV spectroscopy/photometry with the aid of eliminating agents which effectively remove disturbing absorptions caused by other substances. Therein, the concentration of nitrate corresponds to that of nitric acid.

According to the invention, a robust method is proposed by means of which the content of nitric acid in acid mixtures can be determined very precisely, and in fact likewise in fresh as well as in acid mixtures that have been used according to their intended purpose.

The present invention relates to the field of wet chemical treatment of silicon substrates. In particular, the invention relates to a method for the determination of the concentration of nitric acid in aqueous process solutions as they are used for the treatment of substrates such as those made from silicon.

Acid mixtures containing nitric acid (HNO₃) are largely used for cleaning, roughing, but also for planing of different substrates such as in particular those made from silicon. In said acid mixtures, nitric acid is used for the oxidation of the substrate. In addition to the oxidizing component, these acid mixtures contain fluoride containing compounds such as e.g. hydrofluoric acid, ammonium fluoride, sodium fluoride, or such acids that are able to react with, e.g. dissolve, the oxidized substrate.

Further, if necessary, additional ingredients are admixed with these acid mixtures, such as e.g. sulphuric acid, phosphoric acid or tensides.

In the photovoltaics and semiconductor industry, the texturing (roughing) and polishing (planing) of substrates, such as in particular of wafers made from silicon, are amongst the most important applications of such acid mixtures. In the context of the fabrication of elements for the photovoltaics, the so-called edge isolation of wafers can also effectively be carried out with such acid mixtures. Further applications for these acid mixtures relate to e.g. the pretreatment of silicon substrates for the deposition of metals, and to the targeted dissolution of silicon or silicon compounds.

As known to the skilled person, the aforementioned processes are of high economical relevance.

For all of the enlisted applications, the composition of the acid mixtures, and thus also the content of nitric acid as well, is of high relevance for the treatment result.

The modification of the substrate is based on complex chemical reactions of the acids with the substrate surface. Accordingly, the acids are consumed in the course of these reactions, and new reaction products are formed which up to date have obviated a simple, secure and well automatable determination of the content of nitric acid. Thus, in the context of the relevant methods of the invention for the wet chemical acid treatment of silicon substrates, liquid reaction products such as e.g. fluorosilicic acid (H₂SiF₆) and water develop on one hand; but, on the other hand, gaseous reaction products also develop such as e.g. NOₓ and volatile fluoro/silicon compounds that partially ooze out from the process solution, but that, to some extent, are dissolved in the treatment medium as well.

The reaction mechanism, the reaction velocity, as well as the type and the position of the chemical/physical equilibriums vary depending on parameters such as e.g. the relative concentration of the different ingredients, the temperature, the turbulence in the process solution, and the condition of the substrate surface.

There are different older as well most recent comprehensive scientific articles which deal with the clarification of these relationships (see e.g. M. Steinert et al., Study on the mechanism of silicon etching in HNO₃-rich HF/HNO₃ mixtures, J. Phys. Chem., 111, 2133-2140, 2007). These works of fundamental research have contributed to a great extent to the understanding of the processes, but numerous open questions still exist.

Beyond that, intense research is performed since many years in order to expedite practical application of these theoretical insights in the sense of a process-accompanying physical and chemical analysis of the processes (see e.g. A. Henβge, J. Acker, Chemical analysis of acidic silicon etch solution, I. Titrimetric determination of HNO₃, HF, and H₂SiF₆, Talanta 73, 220-226, 2007; J. Acker, A. Henβge, Chemical analysis of acidic silicon etch solution, II. Determination of HNO₃, HF, and H₂SiF₆ by ion chromatography, Talanta 72, 1540-1545, 2007; M. Zimmer et al., In-line analysis and process control in wet chemical texturing process, 22^{nd} European Photovoltaic Solar Energy Conference and Exhibition, Milano, Italy, 2007; W. Weinreich et al., Determination of total fluoride in HF/HNO₃/H₂SiF₆ etch solution by new potentiometric titration methods, Talanta 71, 1901-1905, 2007; U.S. Pat. No. 7,351,349 B2; M. Zimmer et al., Spectroscopical inline analysis of wet chemical process, 23^{rd} European Photovoltaic Solar Energy Conference, Valencia, Spain, 2008; M. Zimmer et al., NIR-spectroscopical process control for wet chemical processes, 24^{th} European Solar Energy Conference, Hamburg, Germany, 2009).

The determination of nitric acid plays a key role in the determination of the process relevant ingredients in the acid mixtures as mentioned. Hence, when knowing the concentration of nitric acid, the content of hydrofluoric acid can also be calculated by way of a simple additional titration with lye in aqueous medium.

For the determination of the nitric acid, the state of the art provides different analyzing methods from the field of titration, NIR-spectroscopy, UV spectroscopy/photometry, and chromatography. However, these known methods do not quite meet the requirements placed upon the present invention with regard to the provision of reliable and precise data.

The sum of the acids can indeed well be determined by means of titration. However, a separate measuring of nitric acid by means of titration is, if at all, only possible under substantial drawbacks. Hence, it is indicated on various occasions that one can titrate nitric acid in the mentioned acid mixtures separately by using organic solvents such as e.g. acetone as titrant instead of water. However, such a titration in solvents is hardly suitable for a use under process conditions. Furthermore, significant problems arise in the presence of silicon (see e.g. A. Henβge and J. Acker, l.c.).

A further possibility for the determination of the nitric acid by means of titration consists in that, in addition to the titration of the acids with lye, a second titration using a solution of lanthanum salt as titrant is performed for the measurement of the sum of the fluoride containing compounds (see W. Weinreich et al., l.c.). The content of nitric acid can be determined by way of netting the results of both titrations.

However, in the context of industrial applications, the titration with a lanthanum salt-solution has a critical economical disadvantage. The element lanthanum belongs to the noble earths. Assuming a performance of six analyses per hour, the amounts of lanthanum required for the permanent measurement of the fluoride containing compounds lie in a region of 50.000 Euros per year.

Most recently, particularly the NIR-spectroscopy is propagated as an alternative for titration regarding the analysis of the nitric acid in the acid mixtures as mentioned.

The acids HF, HNO₃ and H₂SiF₆ can be measured separately with good precision by means of the NIR-spectroscopy in a flow-through cell without measurings and treatments of the sample. Furthermore, the equipment set up is simple, the analysis times are extremely short, the acquisition costs are affordable, and ongoing operating costs are low.

The specific application of the NIR-spectroscopy for the analysis of acid mixtures is described in various publications (see e.g. U.S. Pat. No. 7,351,349 B2; M. Zimmer et al., l.c. (2008); M. Zimmer et al., l.c. (2009)).

The extensive calibration effort required for the preparation of the evaluation models is a disadvantage in the application of the NIR-spectroscopy. In the specific application according to the invention, namely the process analysis of the acid mixtures as mentioned, the NIR-spectroscopy however, also shows particularly serious drawbacks.

The acids HNO₃, H₂SiF₆ and HF which are present in the application according to the invention do not have any own absorptions in the NIR range. The mentioned acids merely deform the absorption bands of water in a specific manner, and can therefore only be determined indirectly. Furthermore, the difference in the specific deformation of the water bands by means of the different acids is extremely small.

Because of that, the use of NIR-spectroscopy for the determination of the mentioned acid mixtures under harsh ambient conditions, as being present in the real industrial application, must be assessed very critically.

Generally, UV spectroscopy/photometry comes also into question for the determination of nitric acid.

It is known that nitrate (NO₃⁻), the anion of nitric acid, does very intensely absorb radiation in the UV range below approx. 330 nm and can thus be measured with correspondingly high sensitivity. Even the low contents of nitrate in waters and sewages which are in the order of magnitude of 1-20 mg/l can be determined directly in the UV range at a wavelength of approximately 220 nm.

The UV spectroscopy/photometry is very precise, sensitive, cost effective and robust, and therefore in principle outstandingly suitable for process analytics. In the literature, on various occasions, its application for the determination of the nitric acid in the mentioned acid mixtures is also described.

However, it has become apparent that the use of these methods in real life is only of limited applicability, namely only as long as the acid mixtures relating to the invention have not been used. Even after a short period of use as intended, i.e. already after only low amounts of substrate were treated with the acid mixtures, the range in the UV spectrum of less than approximately 330 nm which is relevant for the determination of nitrate is irredeemably superimposed with other absorptions.

Ion chromatography provides a way out of this dilemma. Its application for the analysis of the acid mixtures mentioned is extensively covered in literature. However, in view of the necessary sensitive separation columns, the high instrumental effort, and the high maintenance costs, ion chromatography primarily remains an analyzing method for the application in the laboratory.

Despite all efforts, a method for the monitoring and optional control which is robust, i.e. which is usable for any wet chemical application of the aforementioned kind, and which delivers both reliable as well as precise data for nitric acid, could not be found up to date. However, such a method, optionally in combination with a controlled addition of consumed chemicals, is a prerequisite for constant treatment results.

The object of the present invention is therefore the provision of a method by means of which the disadvantages of the prior art can be overcome. In particular, the method according to the invention shall allow for a reliable determination of the concentration of nitric acid in such aqueous media which contain nitric acid and fluoride containing compounds and are used for the wet chemical treatment of silicon substrates. Furthermore, the method shall equally be suited for consumed as well as for fresh media.

The object is solved by provision of the method according to the main claim. Preferred embodiments are subject of the sub claims.

The method according to the invention serves for the determination of the concentration of nitric acid in aqueous media which contain nitric acid and fluoride-containing compounds, in the course of a wet chemical treatment of silicon substrates in which NOₓ compounds are formed, by determination of the concentration of nitrate by means of UV spectroscopy/photometry in the presence or application of at least one agent eliminating the disturbances in the UV absorption spectrum of nitrate caused by NOₓ.

The concentration of nitrate corresponds to the one of nitric acid.

According to the invention, a robust method is proposed by means of which the content of nitric acid in acid mixtures can be determined very precisely, in fact likewise in fresh as well as in used acid mixtures.

It was surprisingly found in the course of experiments carried out regarding the present invention that the disturbance in the UV range of less than approximately 330 nm being important for the nitrate measurement could almost completely be removed by addition of e.g. urea. Hence, the acid mixture can also be measured without additional dilution after addition of urea. Only the layer thickness of the measurement cell must be selected accordingly thin. In this way, it is proved that, contrary to the expectations, no other reaction products which are formed due to the reaction of the acid mixture with the substrate are responsible for the disturbing absorptions in the UV region of less than approximately 330 nm, but primarily NOx compounds.

The term “NOₓ compounds” as used herein relates to nitrogen oxides, nitroso gases or nitrogen oxides, and therefore refers to gaseous oxides of nitrogen. On hand, they are abbreviated by NOₓ, since several nitrogen-oxygen-compounds exist (N₂O, NO, N₂O₃, NO₂, N₂O₄, N₂O₅) because of the many oxidation states of nitrogen.

Further experiments showed that, besides urea, also amidosulphonic acid and other subsequently mentioned agents can individually as well as in combination be used for the elimination of the disturbances in the relevant UV range resulting from present NOₓ compounds.

The mechanism which is used for the elimination of the disturbance of the wavelength range which is important for the determination of nitric acid by means of UV spectroscopy/photometry of less than approximately 330 nm according to the invention varies depending on the actual selection of one or several members from the group of suitable eliminating agents.

The following criteria must be met in the selection and addition or application of a suitable eliminating agent, such that the method according to the invention can successfully be carried out.

The content of nitrate to be measured which corresponds to the amount of present nitric acid may not be altered by the eliminating agent(s). Accordingly, no amounts of nitrate which could impede the measurement may develop during the elimination of the NOₓ disturbance. Further, no relevant amounts of nitrate may be consumed by the application.

The eliminating agent must remove or at least repel the disturbance of the wavelength range in the UV spectrum of less than approximately 330 nm being relevant for the nitrate measurement caused by the NOₓ compounds at least to an extent such that an evaluation of the nitrate peak is possible at least by using the multi variate data analysis.

The eliminating agent itself and its reaction products shall have no absorption in the wavelength range in the UV spectrum of less than approximately 330 nanometers being relevant for the nitrate measurement. At least, the absorption which is generated by the eliminating agent and its reaction products in the mentioned wavelength range must be small enough such that an evaluation of the nitrate peak is possible by using the multi variate data analysis.

The eliminating agent shall remove the disturbing NOₓ compounds in such a manner that no new disturbances caused by the reaction products of the NOₓ compounds develop in the relevant UV range. At least, the disturbance of the nitrate peak in the mentioned wavelength range caused by the reaction products of the NOₓ compounds must be small enough such that an evaluation of the nitrate peak is possible by using the multi variate data analysis.

Taking into consideration the aforementioned criteria, the selection of one or several suitable agents for the elimination of the disturbance(s) caused by NOₓ takes place from the group consisting of:
(1) ammoniac and derivatives of ammoniac, such as e.g. amides like urea, amidosulphonic acids, formamide, acetamide, as well as mixtures thereof. The mechanism is based on the reduction of NOₓ under according reaction conditions to gaseous nitrogen;
(2) amino acids such as in particular glycine and primary amines. The mechanism is based on the reduction of NOₓ under according reaction conditions to gaseous nitrogen via unstable diazonium salt;
(3) other amines such as e.g. sulphanilic acid. The effect is based on the reaction with NOₓ under formation of various compounds such as e.g. diazonium salts;
(4) reduction agents such as e.g. sulphites or sulphuric acid and oxalic acid and their salts. The effect is based on the reduction of NOₓ under according reaction conditions to gaseous nitrogen or other compounds which do not disturb the nitrate peak; and
(5) mixtures thereof.

The substances and compounds proposed above for the selection in the context of the method according to the invention can be added individually as well as in combination as solid state substance or in solution, wherein the respective addition should occur with a molar excess in respect of NOₓ. If necessary, the preperations can be heated for the acceleration of the reaction as required.

According to the invention, the proposed substances and compounds may also be introduced in a sort of a cartridge which is flown through by the sample solution.

According to the invention, the eliminating agent can alternatively or in addition be provided (6) with current carrying (solid-state) electrodes (e.g. B-doped diamond electrodes; glassy carbon electrodes) specially treated with diamond or electron transfer mediators (e.g. thionine or metal porphyrine). The mode of action of this application for the elimination is based on a electrochemical reduction of NOₓ at special electrodes of the aforementioned type. This alternative embodiment does not require, besides the necessary power supply for the electrodes, any of the further substances or compounds listed under (1) to (5).

Eventually, alternatively or in combination with the substances or compounds listed under (1) to (5), according to (7), hydrogen and/or formic acid can be used as an agent for the elimination according to the invention. Here, the electrochemical reduction of NOₓ takes place catalytically e.g. at palladium or at catalysts doped with palladium by means of supplying hydrogen, or by direct generation of hydrogen at the catalyst, or by addition of reduction agents such as e.g. formic acid or formiate.

According to the invention, the concentration of nitrate in the acid mixtures as mentioned can directly be determined after according application of an eliminating agent under application of the UV spectroscopy/photometry.

The nitrate content determined by the method according to the invention can be equaled with the content of sulphuric acid, since practically no other nitrate is present besides the nitrate ions from the nitric acid.

An eliminating agent that is particularly well-suited according to the invention is urea which is used with a molar excess against the NOₓ compounds, wherein an amount of 0.2 mol urea in relation to one liter acid mixture has proven to be sufficient.

With regard to equipment, the elimination can also be designed as a self-optimizing process. In this case, the eliminating agent is automatically dosed multiple times, and the most suitable peak is evaluated.

If necessary, possible remaining interferences of the nitrate spectrum can be mathematically compensated by means of the multi variate data analysis.

In principle, the addition or application of one or several eliminating agents to the sample can occur batch-wise as well as continuously by way of flow-through.

According to a preferred embodiment, measuring cells made from sapphire are used for UV spectroscopy/photometry. Alternatively, the use of measuring cells made from hydrofluorocarbons is proposed, although a significantly higher light power is necessary due to their high self-absorption.

Various illumination means are suitable as light sources for the spectroscopy, such as e.g. continuously emitting deuterium lamps, pulsed xenon flash lamps, or laser light sources. Laser light sources such as e.g. laser diodes are characterized in that they emit light only in a narrow wavelength range, and that they are most recently also available for wavelengths down to ultraviolet (UV) at an acceptable price.

As long as the emission of the laser diode is tuned to the absorption wavelength of the analyte, a broadband photo diode instead of a spectrometer with diffraction grating and diode array is sufficient for detection of the light quantity absorbed.

The method according to the invention is suitable for the online and at-line process analysis as well as for performing the analysis in the laboratory. This is true for the instrumental realization in the form of a single device as well as for the combination with other devices and methods such as e.g. titration and/or NIR spectroscopy.

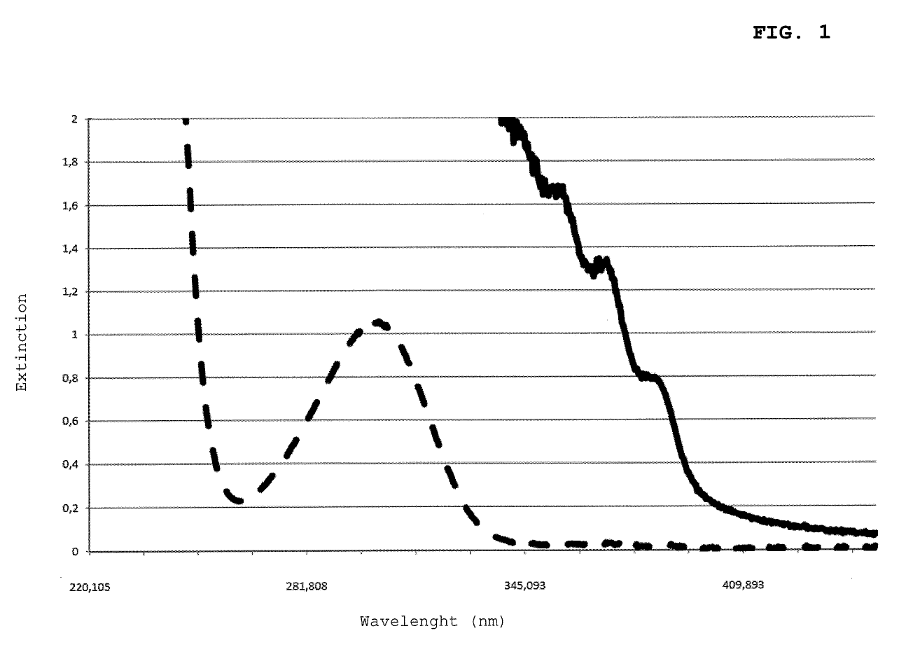

The present invention is described in detail by means of a non-limiting example with reference to FIG. 1.

### EXAMPLE

The method described above was applied in the context of a wet chemical treatment of silicon substrates. The substrates were transported horizontally supported on suitable transport means through a container which contained an etching liquid that comprised, beside water, hydrofluoric acid (15 weight percent) and nitric acid (35 weight percent). Since reaction products form during the etching of silicon substrates which impede or even inhibit the direct real-time determination of nitric acid by means of UV spectroscopy/photometry, 2.5 ml of the sample of the etching liquid were added to 2.5 ml of a 0.2 molar urea solution. By means of this mixture, the spectrometric determination of the amount of nitrate took place by using a cuvette made from sapphire with a layer thickness of 5 mm within a wavelength range of 200 to 330 nm.

The results are depicted in FIG. 1. The continuous line represents the measured UV spectrum of the etching liquid without addition of the eliminating agent. The dashed line shows the result under addition of urea. As depicted, the expected nitrate peak which was masked in the control test because of the formed NOₓ compounds could clearly be shown, so that the reliable quantification of the concentration of nitrate or nitric acid was possible.

1. Method for the determination of the concentration of nitric acid in aqueous media which contain nitric acid and fluoride-containing compounds, in the course of a wet chemical treatment of silicon substrates in which NOₓ-compounds are formed, by determination of the concentration of nitrate by means of UV spectroscopy/photometry in the presence or application of at least one agent eliminating the disturbances in the UV absorption spectrum of nitrate caused by NOₓ.

2. Method according to claim 1, characterized in that the at least one eliminating agent is selected from the group consisting of:
(1) ammoniac and amides;
(2) amino acids and primary amines;
(3) reducing agents;
(4) hydrogen;
(5) formic acid and formate;
(6) current carrying electrodes; and
(7) mixtures thereof.

3. Method according to claim 1, characterized in that urea is used as eliminating means.

4. Method according to claim 1, characterized in that the UV spectroscopy/photometry takes place in a wavelength range of less than or equal to 330 nm.

5. Method according to claim 1, characterized in that measuring cells made of sapphire or UV-light transparent plastics are used for UV spectroscopy/photometry.
